(19) United States
(12) Patent Application Publication
(10) Pub. No.: US 2013/0141917 A1
(43) Pub. Date: Jun. 6, 2013

(54) LED LIGHT DEVICE

(71) Applicants: Tzy-Ying Lin, Hsinchu (TW); Wei-Ping Lin, Taipei (TW); I-Liang Huang, Hsinchu (TW); Jin-Lung Yang, Hsinchu (TW); Chung-Yu Yang, Hsinchu (TW); Tzu-Han Lin, Hsinchu (TW)

(72) Inventors: Tzy-Ying Lin, Hsinchu (TW); Wei-Ping Lin, Taipei (TW); I-Liang Huang, Hsinchu (TW); Jin-Lung Yang, Hsinchu (TW); Chung-Yu Yang, Hsinchu (TW); Tzu-Han Lin, Hsinchu (TW)

(21) Appl. No.: 13/309,421

(22) Filed: Dec. 1, 2011

(51) Int. Cl. F21V 29/00; F21V 21/00

(52) U.S. Cl. 362/294; 362/382

(57) ABSTRACT

The present invention provides an LED light device, including: a heat sink having a layered structure formed by a plurality of tubes; and a sub-mount positioned on the heat sink and mounted with an LED emitter.

### BACKGROUND OF THE INVENTION

1. Field of the Invention

The present invention relates to an LED light device, and in particular relates to an LED light device with high heat dissipation.

2. Description of the Related Art

Light emitting diodes (LEDs) are elements that convert electric energy to light. The LEDs have some advantages including lower power consumption, smaller sizes, higher efficiencies, faster switching, and longer lifetimes, over incandescent light sources. Therefore, LEDs have become popular in illumination devices, such as light bulbs. However, heat dissipation and directional lighting are still issues for LEDs used for general illumination purposes.

FIG. 1 is a perspective view of a conventional LED light bulb. FIG. 2a is a perspective view of a heat sink of the conventional LED light bulb shown in FIG. 1. FIG. 2b is a perspective view of the power driver of the conventional LED light bulb shown in FIG. 1. An LED light bulb 10 comprises at least one LED emitter 11, a diffuser, a heat sink 13, a screw-threaded portion 14, and a power driver 15 (not shown in FIG. 1). The diffuser 11 is arranged to diffuse or scatter the light from the LED emitter 11. The screw-threaded portion 14 is used for mounting the LED light bulb to an Edison socket. The heat sink 13 is a fin structure comprising a plurality of fins arranged around an axis, and the center of the heat sink 13 is made hollow to place a power driver 15 therein.

For the conventional LED light bulb, the heat sink 13 must be hollowed out to place the power driver 15 therein, which increases the volume. Therefore, heat dissipation for the conventional light bulb can be improved. For this purpose, the present invention provides an LED light device provided with a heat sink with a new structure having better heat dissipation than those of prior art.

### BRIEF SUMMARY OF THE INVENTION

A detailed description is given in the following embodiments with reference to the accompanying drawings.

The present invention provides an LED light device, including: a heat sink having a layered structure formed by a plurality of tubes; and a sub-mount positioned on the heat sink and mounted with an LED emitter.

In the LED light device in accordance with an embodiment of the invention, the plurality of tubes include a plurality of first tubes arranged in a first direction in a plane, which form a first layer, and a plurality of second tubes arranged in a second direction in the plane, which form a second layer. The heat sink includes a plurality of the first layers and the second layers piled up alternatively

In the LED light device in accordance with an embodiment of the invention, the plurality of tubes further include a plurality of third tubes perpendicular to the plane of the first layers and the second layers, wherein the third tubes penetrate through the first layers and the second layers, and space apart from the top surface and the bottom surface of the layered structure.

In the LED light device in accordance with an embodiment of the invention, the first direction and second direction are perpendicular. The cross sections of the first, second, and third tubes are rectangular

In the LED light device in accordance with an embodiment of the invention, the plurality of tubes include alumina coated with a nickel layer, or the plurality of tubes include copper.

In the LED light device in accordance with an embodiment of the invention, the sub-mount is further mounted with a power driver module for driving the LED emitter.

In the LED light device in accordance with an embodiment of the invention, the LED light device further includes a cylindrical lens covering the LED emitter and blended with phosphor.

For the cylindrical lens, the cylindrical lens has a cylindrical recess used for accepting the LED emitter, and an opposite surface of the cylindrical recess is a curved surface, wherein the curved surface can be convex or concave. When the curved surface is concave, the shape of the space surrounded by the curved surface can be a frustum with a cap and base according to an embodiment of the invention. In an embodiment, the angle between the base and the side surface of the frustum is larger than 30 degrees, and the diameter of the cap is longer than the width of the blue LED emitter.

In the LED light device in accordance with an embodiment of the invention, the LED emitter includes a white LED emitter, a red LED emitter, a green LED emitter, and a blue LED emitter, wherein the white LED emitter is located at the center of the sub-mount, and the red LED emitter, the green LED emitter, and the blue LED emitter surround the white LED emitter. In this case, the sub-mount is further mounted with a dimmable IC and a switch circuit, wherein the switch circuit is switched to several states to control the LED emitters to select a desired colored light.

The present invention also provides an LED light device, including a heat sink having a layered structure formed by the piling up of a plurality of tubes, and a plurality of light engines, each of which includes a sub-mount positioned on the heat sink, an LED emitter mounted on the sub-mount, and a power driver module mounted on the sub-mount for driving the LED emitter, wherein at least one of the plurality of light engine is selected to emit light depending on the power requirement.

In an embodiment of the present invention, the LED light device includes a ceiling light, a floor light, a high bay, and a track light.

According to the present invention, an LED light device is provided. This LED light device has a heat sink with a tube-constructed structure, which has better heat dissipation than those of prior art.

### BRIEF DESCRIPTION OF THE DRAWINGS

The present invention can be more fully understood by reading the subsequent detailed description and examples with references made to the accompanying drawings, wherein:

FIG. 1 is a perspective view of a conventional LED light bulb.

FIG. 2a is a perspective view of the heat sink of the conventional LED light bulb shown in FIG. 1.

FIG. 2b is a perspective view of the power driver of the conventional LED light bulb shown in FIG. 1.

FIG. 3a is a perspective view of an LED light bulb in accordance with an embodiment of the invention.

FIG. 3b is a perspective view of the LED light bulb shown in FIG. 3a, wherein the diffuser is removed.

FIG. 3c is a perspective view of the LED light bulb shown in FIG. 3b, wherein the light engine is removed.

FIG. 4 is a side view of a heat sink in accordance with an embodiment of the invention.

FIG. 5 is a perspective view of a heat sink in accordance with another embodiment of the invention.

FIG. 6 is a diagram showing a light engine in accordance with an embodiment of the invention.

FIG. 7 is a diagram showing a light engine in accordance with another embodiment of the invention.

FIG. 8a is a perspective view of a part of a LED light bulb in accordance with an embodiment of the invention.

FIG. 8b is a perspective view of the cylindrical lens shown in FIG. 8a.

FIG. 8c is a cross-sectional view of the cylindrical lens and the LED emitter shown in FIG. 8a.

FIG. 9a is a perspective view of a cylindrical lens in accordance with another embodiment of the invention.

FIG. 9b is a cross-sectional view of the cylindrical lens shown in FIG. 9a.

FIG. 10a is a perspective view of a cylindrical lens in accordance with another embodiment of the invention.

FIG. 10b is a cross-sectional view of the cylindrical lens shown in FIG. 10a. From Figs

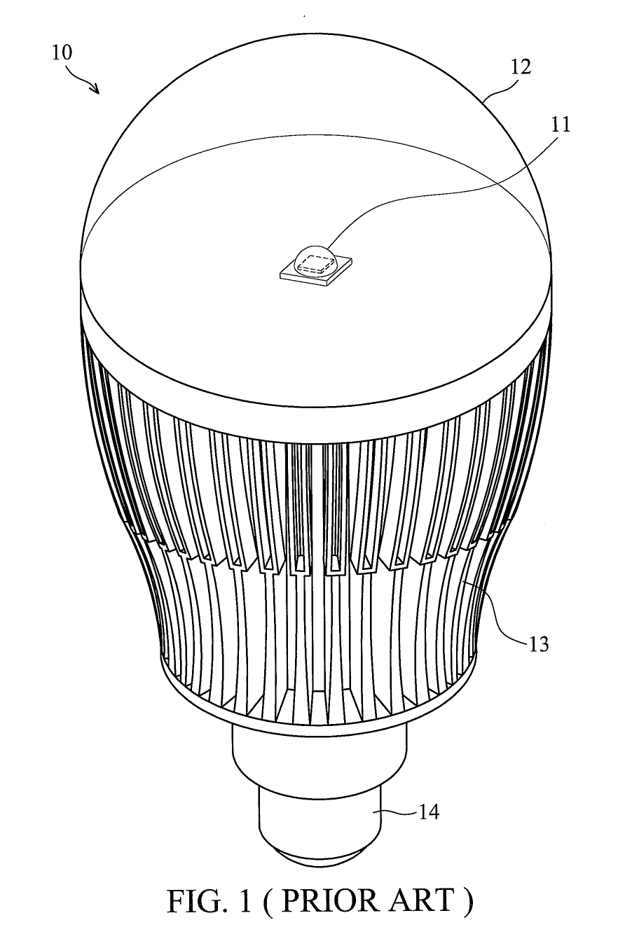

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

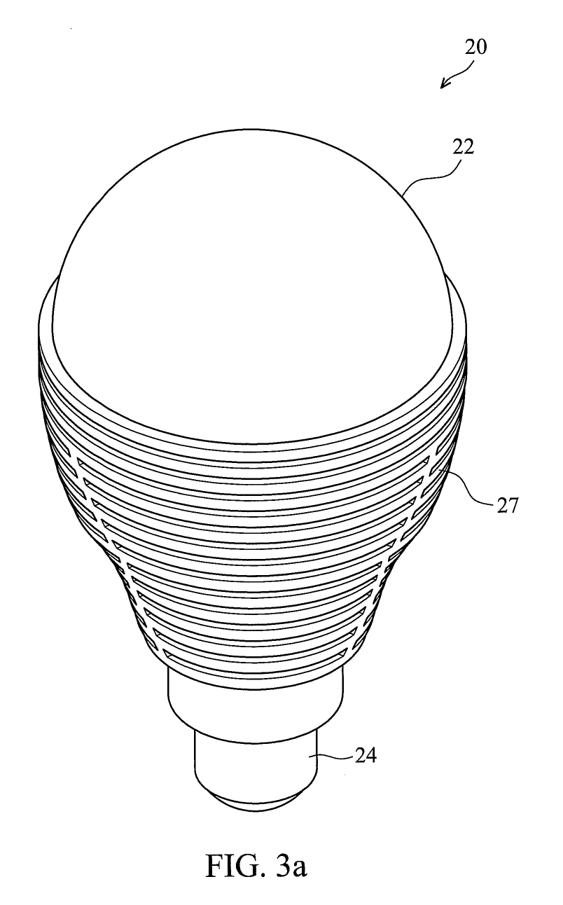

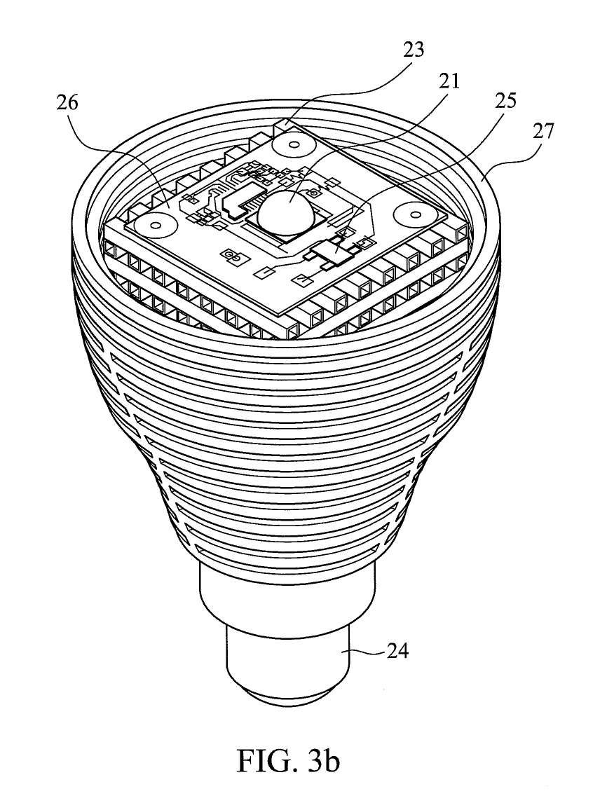

FIG. 3a is a perspective view of an LED light bulb in accordance with an embodiment of the invention. As shown in FIG. 3a, an LED light bulb 20, from its appearance, comprises a diffuser 22, a heat sink case 27, and a screw-threaded portion 24. FIG. 3b is a perspective view of the LED light bulb shown in FIG. 3a, wherein the diffuser is removed. In FIG. 3b, a heat sink 23 and a sub-mount 26 positioned on the heat sink 23 are seen. On the sub-mount 26, an LED emitter 21, a power driver module 25, and other peripheral circuits are mounted. Here, the sub-mount 26 and the elements integrated thereon are called a light engine. Detailed description of the light engine will be recited later. First, the following description will focus on the structure of the heat sink 23.

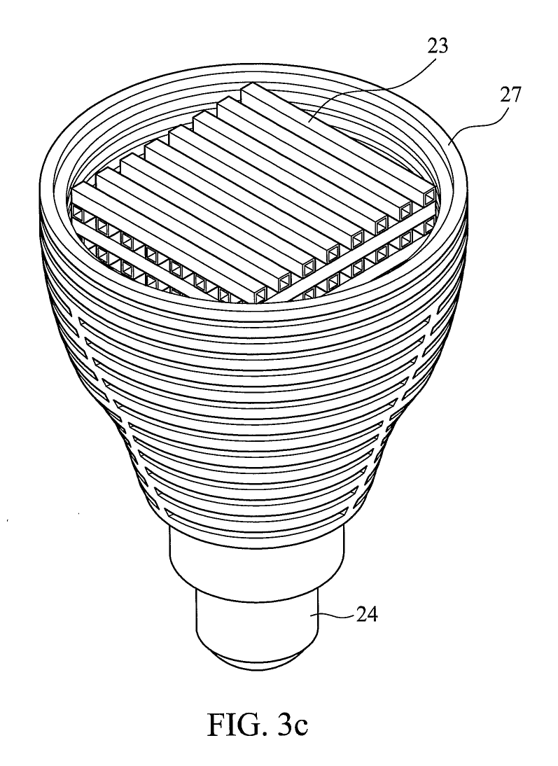

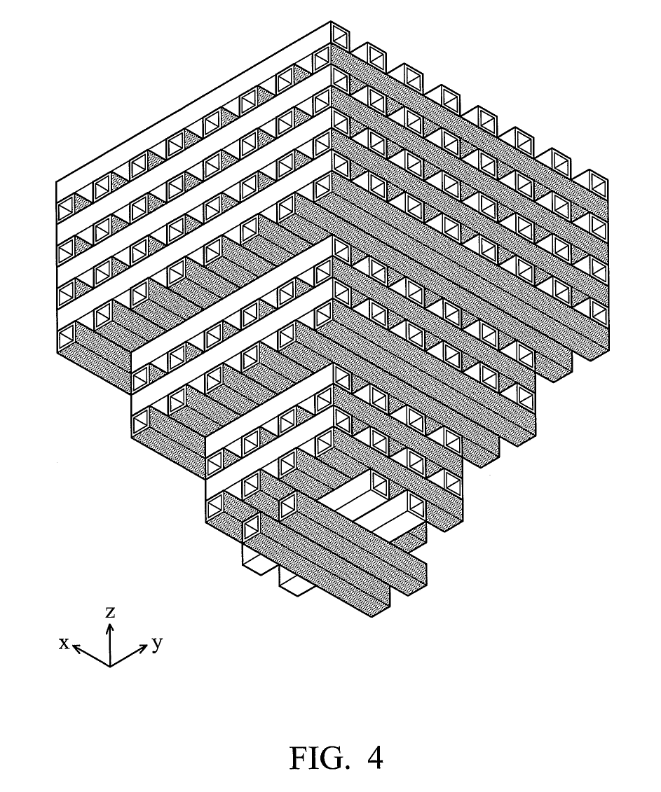

FIG. 3c is a perspective view of the LED light bulb shown in FIG. 3b, wherein the light engine is removed. As shown in FIG. 3c, the heat sink 23 which looks like a cube is put in the heat sink case 27. To discuss the structure of the heat sink 23, a side view of this cube-shaped heat sink is shown in FIG. 4. The heat sink has a layered structure, wherein each layer comprises a plurality of tubes arranged in parallel. In the embodiment, the cross sections of the tubes are rectangular and the tubes are arranged along an X axis or Y axis. The layer constructed by the tubes arranged along the X axis and the layer constructed by the tubes arranged along the Y axis pile up alternatively to form the whole layered structure of the heat sink. Note that to fit in the heat sink case, which narrows at the bottom, the plane area of the lower layer of the heat sink may be smaller than the plane area of the upper layer. Therefore, the number and the length of the tubes in a layer are reduced as the layer moves to the bottom of the heat sink.

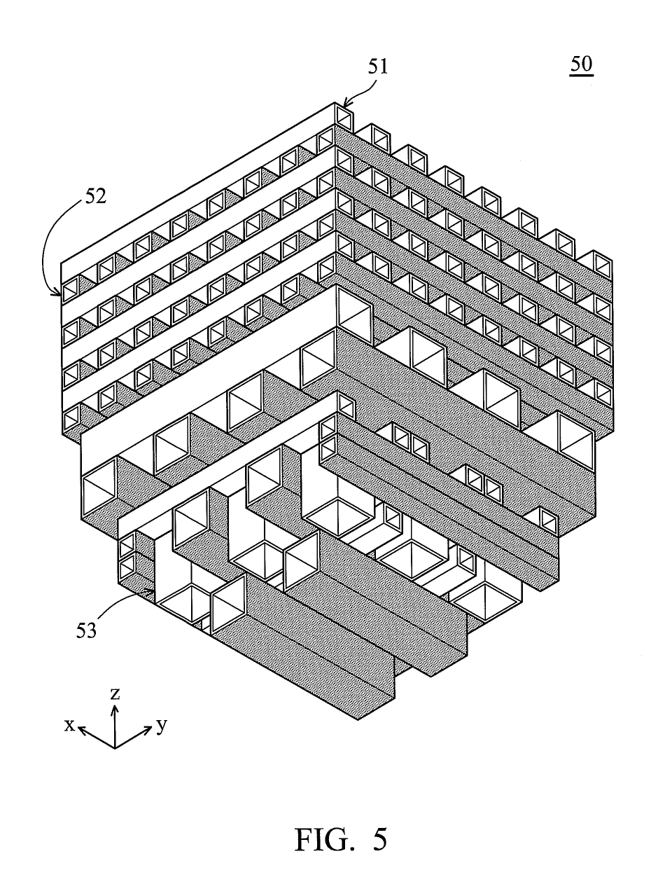

In this embodiment, the number of the layers is not limited, but at least 6 layers are preferred. Also, the number of the tubes in a layer is not limited, but at least 3 tubes in a layer are preferred. The size of the tubes is also not limited. The heat sink can be formed by layers constructed by thick tubes together with layers constructed by thin tubes (refer to FIG. 5 described later). The tubes can be made of alumina or copper, but are not limited thereto. Other materials having good heat transfer efficiency can also be utilized. However, in the case where the tubes are alumina, the tubes need to be coated with a solder material, such as a nickel layer, for soldering with other tubes.

According to the structure of the heat sink of the embodiment, given the same volume, the total surface areas of the tube-constructed heat sink are much greater than those of the conventional fin-structured heat sink. Therefore, heat dissipation in the tube-constructed heat sink is better than in the conventional fin-structured heat sink. Heat can be quickly transferred along the X and Y axes by conduction.

FIG. 5 is a perspective view of a heat sink in accordance with another embodiment of the invention. In this embodiment, in addition to tubes 51 arranged along the X axis and tubes 52 arranged along the Y axis, the heat sink 50 further comprises several tubes 53 arranged along a Z axis. The tubes 53 are inserted into the gap between the tubes 51 and the gap between the tubes 52. The tubes 53 can perform the role of smokestacks to transfer heat by convection. Note that the ends of the tubes 53 do not reach the top surface and the bottom surface of the heat sink 50. Because the function of tubes 53 is to transfer heat along the Z axis not only by conduction but also by convection, if the ends of tubes 53 reach the top surface or the bottom surface of the heat sink 50, there is no room for air to flow in or flow out of the tubes 53. In this regard, an appropriate distance should be kept respectively between the bottom ends of the tubes 53 and the bottom surface of the heat sink 50, and between the top ends of the tubes 53 and the top surface of the heat sink 50, so that heat dissipation by convection can be performed.

According to the structure of the heat sink of the embodiment, heat can be transferred by both conduction and convection. In comparison with the heat sink not having tubes arranged along the Z axis, the heat sink having tubes arranged along the Z axis has better heat transfer efficiency.

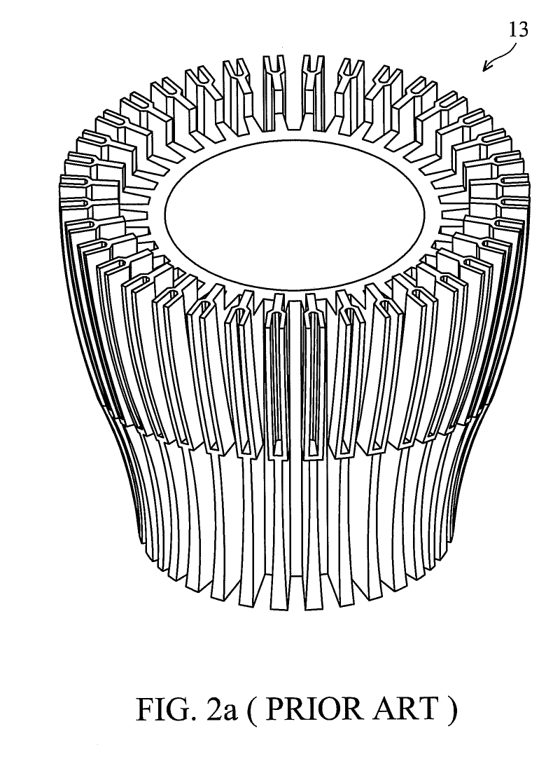

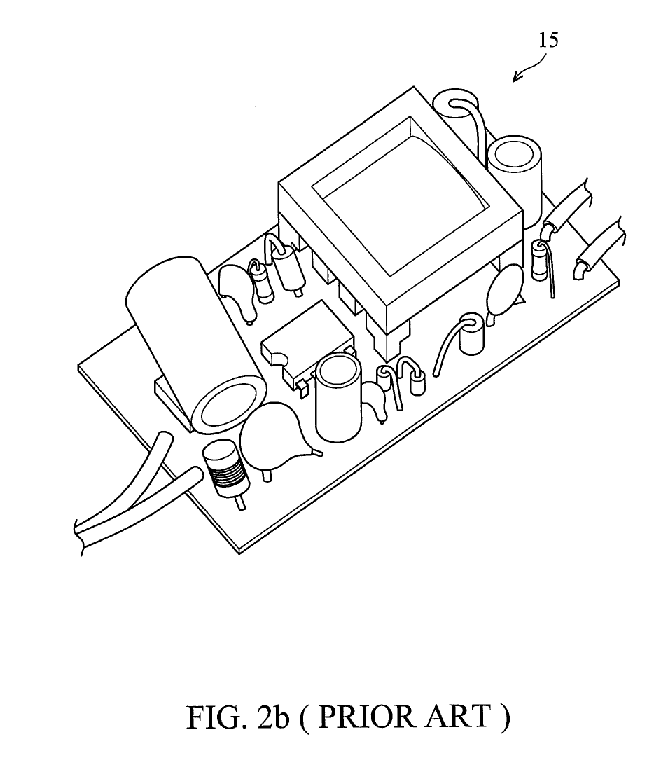

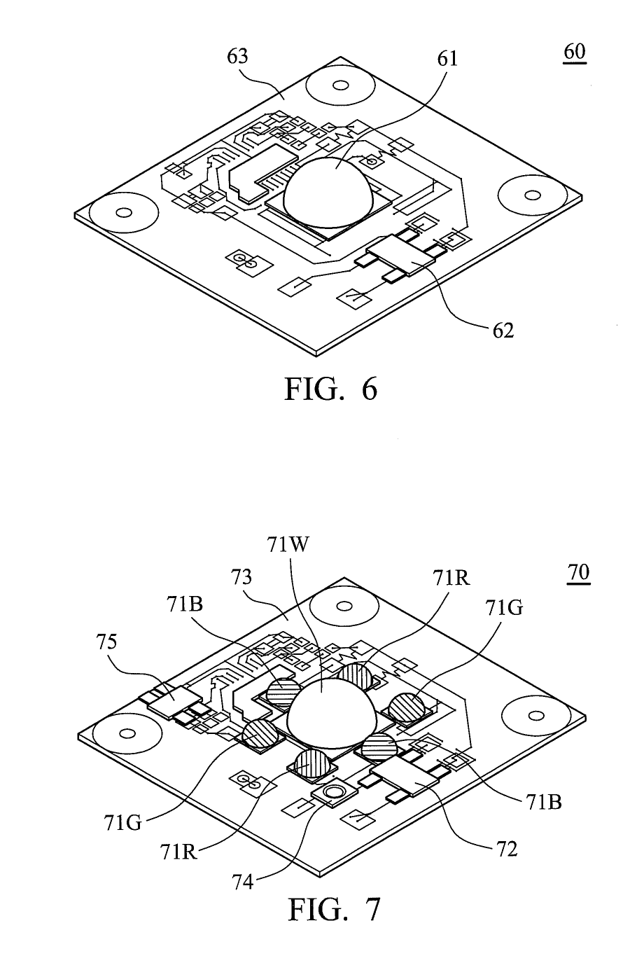

FIG. 6 is a diagram showing a light engine in accordance with an embodiment of the invention. Because the heat sink of the present invention has no room to put a huge power driver (such as power driver 15 shown in FIG. 2b) therein, a light engine 60 is provided in the present invention, wherein an LED emitter 61, a power driver module 62 and other peripheral circuits are all integrated on a single sub-mount 63. The light engine 60 only occupies a small volume, so that it can be just placed on the top surface of the heat sink. Therefore, the light bulb of the present invention does not need to make a space for a huge power driver and the layer-structured heat sink described before can be actually utilized in the LED light bulb. Note that for a white LED light bulb, the LED emitter 61 can be a white LED emitter or a blue LED emitter. In the case of a blue LED emitter, there should be an additional lens mixed or applied with phosphor covering the blue LED emitter. The additional lens mixed or applied with phosphor can absorb at least some of the blue light emitted by the blue LED emitter and re-emit yellow light. This allows the bulb to emit a white light combination of blue and yellow light. Detailed description for the additional lens will be recited later.

FIG. 7 is a diagram showing a light engine in accordance with another embodiment of the invention. As shown in FIG. 7, a plurality of LED emitters can be integrated on a sub-mount. A light engine 70 comprises a sub-mount 73, a plurality of LED emitters 71W, 71R, 71G, and 71B, a power driver module 72, a switch circuit 74, and a dimmable IC 75. The LED emitters comprise a white LED emitter 71W located at the center of the sub-mount 73, at least one red LED emitter 71R, at least one green LED emitter 71G, and at least one blue LED emitter 71B, wherein the red LED emitters 71R, green LED emitter 71G, and the blue LED emitter 71B surround the white LED emitter 71W. The switch circuit 74 is used to switch on a part of LED emitters and switch the others to generate a desired colored light. In this structure, the light bulb can emit more than one colored light, such as red, green, blue, yellow, cyan, magenta, or white light. The dimmable IC is used to dynamically adjust the current flowing to the LED emitters and therefore increases or decreases its intensity. Note that for a white LED light bulb, the light engine 70 can emit white light itself, so that an additional lens mixed or applied with phosphor is not necessary.

By using the light engine 70 in the LED light bulb, the color and the intensity of the light emitted from the LED light bulb can be easily controlled. Therefore, the light bulb can change the atmosphere of the environment, which satisfies requirements for different occasions.

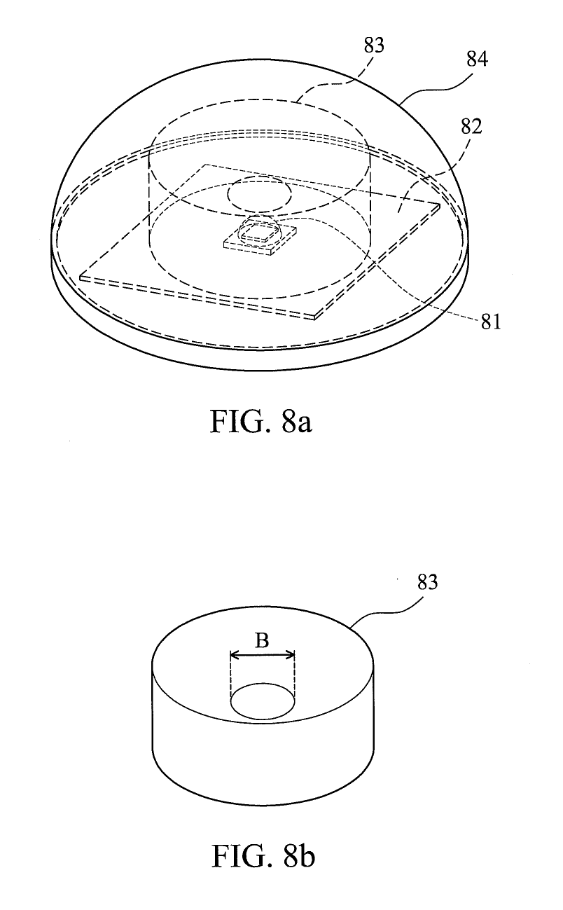

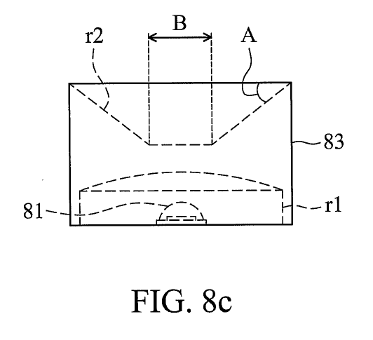

FIG. 8a is a perspective view of a part of a LED light bulb in accordance with an embodiment of the invention. In FIG. 8a, a part of a light bulb comprises an LED emitter 81, a sub-mount 82, a cylindrical lens 83, and a diffuser 84. The LED emitter 81 is a blue LED emitter. The cylindrical lens 83 is mixed with phosphor so as to absorb at least some of the blue light emitted by the blue LED emitter and re-emit yellow light, as described above.

FIG. 8b is a perspective view of the cylindrical lens shown in FIG. 8a, and FIG. 8b is a cross-sectional view of the cylindrical lens and the LED emitter shown in FIG. 8a. From FIGS. 8b and 8c, it is understood that the cylindrical lens 83 has recesses r1 and r2 at two end surfaces of its cylindrical body, respectively. The recess r1 at the bottom end surface provides a space to accept the LED emitter 81. This space is also a cylinder, wherein the top surface of the recess r1 is a concave surface with respective to the cylindrical lens 83. The recess r2 at the top end surface forms a space which is a frustum with a circular base. The frustum with a circular base is the portion of a cone that lies between two parallel planes cutting it. One plane of the frustum, which is smaller than the other, is called a cap and the other plane is called a base. Here, the base of the frustum formed by the recess r2 faces up, and the cap of that faces down. In this embodiment, the angle A between the side surface and the base of the frustum is preferred to be larger than 30 degrees, and the cap diameter B of the frustum is preferred to be longer than the width of the LED emitter 81.

According to the structure of the cylindrical lens 83, two recesses r1 and r2 respectively provide a curved surface which reflects or refracts light emitted from the LED emitter 81. Therefore, the light can be output from the light bulb with a larger angle range. For this embodiment, the illumination angle of the light bulb can be larger than 270 degree.

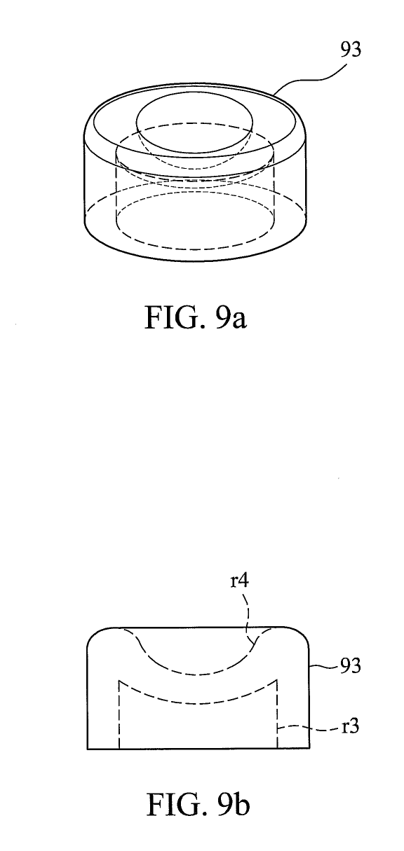

FIG. 9a is a perspective view of a cylindrical lens in accordance with another embodiment of the invention, and FIG. 9b is a cross-sectional view of the cylindrical lens shown in FIG. 9a. From FIGS. 9a and 9b, it can be understood that the difference between the cylindrical lens 83 and the cylindrical lens 93 is the shape of their recesses. The cylindrical lens 93 has recesses r3 and r4 at two end surfaces of its cylindrical body, respectively. The recess r3 at the bottom end forms a space which is a cylinder and the top end surface of the recess r3 is a convex surface with respective to the cylindrical lens 93. The recess r4 at the top end surface shapes the top end surface as a concave surface.

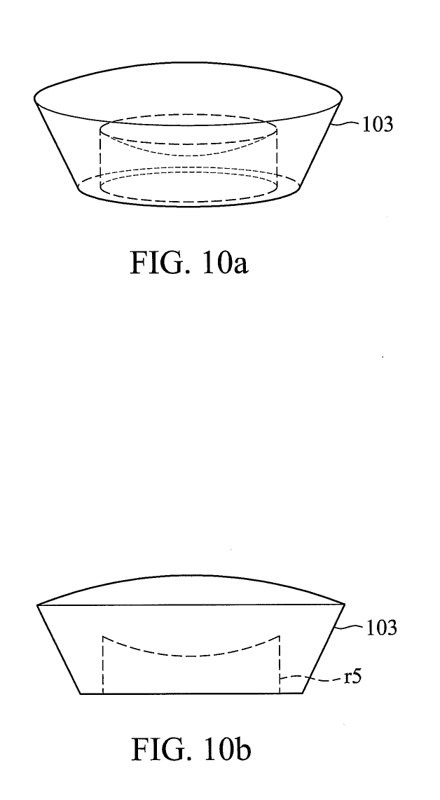

FIG. 10a is a perspective view of a cylindrical lens in accordance with another embodiment of the invention, and FIG. 10b is a cross-sectional view of the cylindrical lens shown in FIG. 10a. As shown in FIGS. 10a and 10b, the side surface of the cylindrical lens 103 extends outwardly from rather than stands perpendicular to the bottom. Moreover, the cylindrical lens 103 only has a recess r5 at the bottom end surface of its cylindrical body. The recess r5 at the bottom end forms a space which is a cylinder and the top end surface of the recess r5 is a convex surface with respective to the cylindrical lens 103. There is no recess at the top end surface of the cylindrical lens 103. The top end surface of the cylindrical lens 103 is a convex surface.

According to the above three embodiments, as long as the top end surface of the recess at the bottom end of the cylindrical lens and the top end surface of the cylindrical lens are curved surfaces so as to reflect or refract light to a wide illumination angle, there is no special limit to the curved surface. The curved surface can be a concave surface, or a convex surface with respect to the cylindrical lens. In addition, the cylindrical lens mixed with phosphor can provide more uniform white light output than the cylindrical lens applied with phosphor on its surface can do.

The above description recites the features of the heat sink, the light engine, and the cylindrical lens in an LED light bulb in accordance with the present invention. However, the heat sink and the light engine can further be utilized in other indoor or outdoor light devices, such as a ceiling light, a floor light, a high bay, a track light, or etc. In these light devices, the number of the light engine is not limited to 1. A plurality of the light engines can be connected in series or in parallel. In this case, a switch circuit or a control device can be provided in these light devices to select at least one light engine to emit light depending on the power requirement.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An LED light device, comprising:
a heat sink having a layered structure formed by a plurality of tubes; and
a sub-mount positioned on the heat sink and mounted with an LED emitter.

2. The LED light device as claimed in claim 1, wherein the plurality of tubes comprise a plurality of first tubes arranged in a first direction in a plane, which form a first layer, and a plurality of second tubes arranged in a second direction in the plane, which form a second layer.

3. The LED light device as claimed in claim 2, wherein the heat sink comprises a plurality of the first layers and the second layers piled up alternatively.

4. The LED light device as claimed in claim 2, wherein the plurality of tubes further comprise a plurality of third tubes perpendicular to the plane of the first layers and the second layers, wherein the third tubes penetrate through the first layers and the second layers, and space apart from the top surface and the bottom surface of the layered structure.

5. The LED light device as claimed in claim 2, wherein the first direction and second direction are perpendicular.

6. The LED light device as claimed in claim 4, wherein the cross sections of the plurality of tubes are rectangular.

7. The LED light device as claimed in claim 4, wherein the plurality of tubes comprise alumina coated with a nickel layer.

8. The LED light device as claimed in claim 4, wherein the plurality of tubes comprise copper.

9. The LED light device as claimed in claim 1, wherein the sub-mount is further mounted with a power driver module for driving the LED emitter.

10. The LED light device as claimed in claim 1, further comprising:
a cylindrical lens covering the LED emitter and blended with phosphor.

11. The LED light device as claimed in claim 10, wherein the cylindrical lens has a cylindrical recess used for accepting the LED emitter, and an opposite surface of the cylindrical recess is a curved surface.

12. The LED light device as claimed in claim 11, wherein the curved surface is convex or concave.

13. The LED light device as claimed in claim 12, wherein in the case where the curved surface is concave, the shape of the space surround by the curved surface is a frustum with a cap and base.

14. The LED light device as claimed in claim 13, wherein the angle between the base and the side surface of the frustum is larger than 30 degrees.

15. The LED light device as claimed in claim 13, wherein the diameter of the cap is longer than the width of the LED emitter.

16. The LED light device as claimed in claim 1, wherein the LED emitter comprises a white LED emitter, a red LED emitter, a green LED emitter, and a blue LED emitter.

17. The LED light device as claimed in claim 16, wherein the white LED emitter is located at the center of the sub-mount, and the red LED emitter, the green LED emitter, and the blue LED emitter surround the white LED emitter.

18. The LED light device as claimed in claim 17, wherein the sub-mount is further mounted with a dimmable IC and a switch circuit, wherein the switch circuit is switched to several states to control the LED emitters to select a desired colored light.

19. An LED light device, comprising:
a heat sink having a layered structure formed by the piling up of a plurality of tubes; and
a plurality of light engines, each of which comprises a sub-mount positioned on the heat sink, an LED emitter mounted on the sub-mount, and a power driver module mounted on the sub-mount for driving the LED emitter,
wherein at least one of the plurality of light engine is selected to emit light depending on the power requirement.

20. The LED light device as claimed in claim 19, wherein the light device comprises a ceiling light, a floor light, a high bay, and a track light.
